(19) United States
(12) Patent Application Publication
(10) Pub. No.: US 2006/0149942 A1
(43) Pub. Date: Jul. 6, 2006

(54) Microcontroller and assigned method for processing the programming of the micro-con- troller

(76) Inventors: Juergen Schroeder, Hamburg (DE); Detlef Mueller, Barsbuettel (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/535,755

(22) PCT Filed: Nov. 17, 2003
(86) PCT No.: PCT/IB03/05192

§ 371 Date: May 19, 2005

(30) Foreign Application Priority Data
Nov. 22, 2002 (DE) 102 54 657.6

(51) Int. Cl. G06F 9/44

(52) U.S. Cl. 712/234

(57) ABSTRACT

In order to further develop a microcontroller (100) the programming of which is carried out in at least one machine-dependent assembler language in which the assembler commands, with the exception of conditional program jumps or branches, can be executed in essence independently of data, together with a method for processing the programming of the microcontroller (100) carried out in at least one machine-dependent assembler language, in such a way that the program running on the microcontroller (100) is entirely secret and unpredictable, i.e. is not reproducible, for an external observer, it is proposed that the program jumps or branches are executed—in dependence on the state of at least one random number generator (10) and/or—independently of the internal state of the programming of the microcontroller (100).

The present invention relates to a microcontroller the programming of which is carried out in at least one machine-dependent assembler language in which the assembler commands, with the exception of conditional program jumps or program branches, respectively, can be executed in essence independently of data.

The present invention also relates to a method for processing the programming of a microcontroller of the above-mentioned type carried out in at least one machine-dependent assembler language.

One-chip microcomputers which as a rule are used for controlling devices and in which the Central Processing Unit (CPU), memory and ports are integrated on one chip are referred to as microcontrollers. The programming of microcontrollers is executed in machine-dependent assembler language. In the known assembler languages all assembler commands, with the exception of conditional program jumps or program branches, are executed independently of data.

A conditional program jump or program branch is generally realized as follows: The condition to be checked, as a rule at least one status flag, is tested. If it is found that a jump or branch should take place, the program counter is loaded with a new program address (=with a new “value”). If no jump or branch is to take place, the instruction is ended, since, of course, the program counter automatically contains the next value, i.e. the next address.

Such a procedure entails that, in the case of conditional program jumps or conditional program branches, a time difference may occur in the execution of the instruction. The reason for this time difference in the execution of the instruction is that, in the case of a program jump or branch, the program counter is additionally set to a new value (to a new program address), whereas in the case of a non-jump or a non-branch the instruction is ended after the condition test.

This means that the execution of commands for conditional jumps or branches in microcontroller programs usually has different execution times and therefore also different current values, which can be determined by means of dynamic current measurements, depending on whether or not a conditional jump or branch is executed.

A current method of software analysis, which also allows misuse by hackers, for example, to determine cryptographic keys, consists in identifying conditional program jumps or branches by means of a special timing analysis and drawing conclusions regarding the processed data using the identified program run.

Conclusions regarding the data tested in this instruction can therefore be drawn solely by means of the time sequence of the conditional jump instruction or branch instruction, which, for example in the case of an unauthorized hacking of especially security-sensitive sections of a microcontroller program, such as a cryptographic key, is extremely disadvantageous.

In the implementation of software which performs actions on a microcontroller, which actions are to remain hidden to an unauthorized observer, a major problem therefore exists in that—formulated in the abstract—the unauthorized observer can, by means of physical measurements, obtain information on the code executed and on the data used in its execution. This problem occurs in particular with security-relevant software as used, for example, in smartcards. Typical attempts to obtain information about the code executed and about the data used in executing it consist in measuring the current and/or the voltage supplied to the microcontroller. Information about the internal program sequence can, however, also be obtained using other physical measuring procedures.

Against the background of the above-described possibilities of spying on the program running internally on a microcontroller, the possibility of concealing this program appears desirable. However, only random variations with regard to the individual instructions executed, but not with regard to larger program sections, have been conventionally known hitherto, so that concealment of the program running internally on the microcontroller is possible in only a limited fashion or not possible at all.

Starting from the above-described disadvantages and deficiencies, and taking account of the state of the art which has been sketched (=completely reproducible processing of the program running on a microcontroller as a function of the data to be processed), it is an object of the present invention to further develop a microcontroller of the above-mentioned type as well as a method of the above-mentioned type, in such a way that the program running on the microcontroller is completely secret and unpredictable, i.e. is not reproducible, for an external observer.

This object is achieved by a microcontroller having the features specified in claim 1 and by a method having the features specified in claim 5. Advantageous embodiments and useful aspects of the present invention are characterized in the respective dependent claims.

The teaching of the present invention is therefore to be seen in a randomly controlled run of the programming in the microcontroller. This means that by means of suitable processing of random numbers generated by means of at least one random number generator it is possible to cause a program running on the microcontroller to run unpredictably and non-reproducibly for an external observer. To this end an instruction sequence leading to the desired action can be selected from a large number of possible instruction sequences by the use of a Random Number Generator (RNG) in a manner essential to the invention. Because a plurality of different instruction sequences lead to the same result, the external observer cannot reconstruct or analyze the current action of the microcontroller as a result of the selected instruction sequence. By means of a random program run of this kind according to the invention, conclusions regarding the processed data are made considerably more difficult or are entirely prevented.

Accordingly, through the hardware implementation of the microcontroller and through the assigned method according to the present invention, it is less the observation than the understanding and analyzing of the internal program run on the microcontroller that is made more difficult. In this connection, it is assumed that it is certainly possible for the unauthorized observer to obtain information about the executed code.

An essential component of the present invention is the possibility of randomly executing jumps or branches in the program independently of internal states of the software. The hardware of the microcontroller, together with the hardware random number generator provided, offers the possibility of executing or refusing a program jump or branch, depending on the state of the random number generator. The states and the values of the random number generator are not visible from the outside.

According to a particularly inventive aspect an identical functionality of program jumps or branches can be achieved by executing various, differently implemented program jumps or branches; i.e. a different coding is present for the same function. Alternatively, or additionally, a different functionality of program jumps or branches can be brought about in a specified way.

According to a preferred embodiment of the present invention, a further improvement in rendering conditional jumps or branches invisible is obtained if forward and backward jumps or branches are combined, so that a very large number of differently implemented program jumps or branches, which according to the invention can be selected and executed at random, are produced relatively quickly; thus, in the case of the example of a binary tree with forward jumps, e.g. sixteen jumps, i.e. 16⁴=65,536 possibilities of executing the program differently, are produced.

The program run according to the invention exhibits an unpredictable and non-reproducible behavior to the outside observer. Because conclusions regarding internal states or data of the microcontroller cannot be drawn from such a program run with a large number of jumps or branches, the method according to the present invention provides an effective method for concealing these states and/or data from an unauthorized observer; this results in a secure operation of microcontrollers, in particular smartcard controllers, above all in the case of conditional program jumps or branches, respectively.

The hardware implementation of the microcontroller with random number generator is advantageously possible in many ways, four fundamental implementation methods being especially recommended, independently of or in combination with one another, for carrying out the method according to the present invention:
(i) reading of the random number generated by the random number generator via the register of the software and subsequent evaluation of the random number read with the conditional program jump or branch;
(ii) if at least one, particularly bit-addressable, Random Number Register (RNR) is arranged in the microcontroller, testing per bit of the random number register and conditional branching;
(iii) implementation of the corresponding assembler command “branch on random bit”, a defined bit of the random number register being supplied directly to the condition input for the conditional jump or branch;
   (=quickest and most convenient implementation with the lowest software complexity and cost); and/or
(iv) as a variant of the method described re point (iii):
   temporary replacement of an Arithmetic Logic Unit (ALU) flag (ALU=logic calculating unit found in microcontrollers), which usually controls conditional jumps or branches, by a bit from the random number register; replacement of the ALU flag can be effected via the software, the conditional jumps or branches corresponding to the ALU bit then being controlled by a bit of the random number register; in this period the ALU flag is not available for conditional jumps or branches, respectively.

To sum up, considerable advantages are to be seen in the present invention in the substantially more difficult possibilities of analyzing the internal states or data in the case of conditional jumps or branches. Consequently, the present invention always gives rise to the same dynamic current values, independently of the structure of the (microcontroller) program, and thus prevents abusive and unauthorized exploration of time-conditioned dynamic current analyses.

The present invention finally relates to an electrical or electronic device controlled by means of at least one microcontroller of the above-described type.

As already discussed above, there are various possible ways of advantageously embodying and further developing the teaching of the present invention. In this regard reference is made, on the one hand, to the claims depending on claim 1 and claim 5 and, on the other hand, further embodiments, features and advantages of the present invention elucidated with reference to the example of embodiment shown in the drawing, in which:

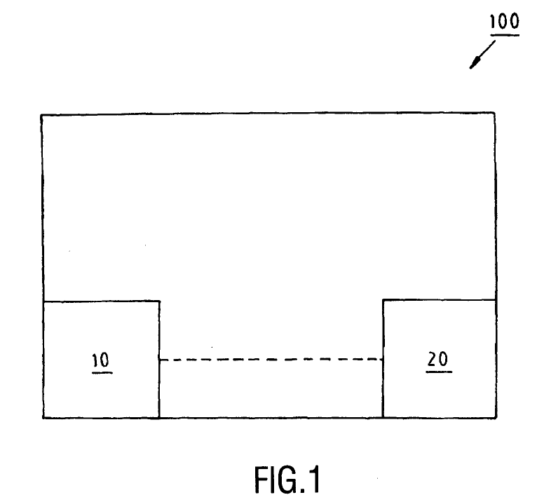

FIG. 1 is in a schematic representation of a block diagram of an example of embodiment of a microcontroller according to the present invention operated with the method according to the present invention.

FIG. 1 illustrates an embodiment of a microcontroller 100 configured as a smartcard controller for controlling an electrical or electronic device the programming of which is carried out in a machine-dependent assembler language and is processed. In this processing the assembler commands, with the exception of conditional program jumps or branches, are executed according to the method independently of data.

The microcontroller 100 is distinguished by the fact that a random number generator 10 is assigned to the microcontroller 100, by means of which the program jumps or branches can be executed in dependence on the state of the random number generator 10 and independently of the internal state of the programming of the microcontroller 100.

Consequently, an identical functionality of program jumps or branches can be achieved by executing various, differently implemented program jumps or branches; i.e. a different coding is present for the same function.

To achieve this, the random number generated by the random number generator 10 is read via the register of the software and then evaluated with a conditional program jump or branch. Alternatively, or in addition to this, the presence of a bit-addressable random number register 20 assigned to the random number generator 10 provides that test can be made per bit of the random number register 20 and a conditional jump or branch can be carried out.

The most convenient and quickest implementation with the lowest software complexity and cost consists in implementing an assembler command (“branch on random bit”), a defined bit from the random number register 20 being supplied directly to the condition input for the conditional jump or branch.

The programming of the microcontroller 100 also permits a variant of the above in which an Arithmetic Logic Unit (ALU) flag is replaced through the software by a bit of the random number register 20, so that the conditional jumps corresponding to the Arithmetic Logic Unit are controlled by the bit of the random number register 20.

By means of the microcontroller 100 according to FIG. 1 and by means of the method for processing the programming of the microcontroller 100, this programming running on the microcontroller 100 can be completely concealed in that through suitable processing of the random numbers generated by the random number generator 10 a program running on the microcontroller 100 runs in a way that is unpredictable and non-reproducible by an external observer.

For this purpose, through the use of the random number generator 10, an instruction leading to the desired action is selected from a large number of possible instructions. Because a plurality of different instructions lead to the same result, the external observer cannot reconstruct or analyze the current action of the microcontroller 100 as a result of the selected instruction. Through a random program run of this kind, therefore, conclusions regarding processed data are made considerably more difficult or are entirely prevented.

### LIST OF REFERENCE NUMERALS

100 Microcontroller, in particular smartcard controller
10 Random Number Generator (RNG)
20 In particular bit-addressable random number register (RNR)

1. A microcontroller the programming of which is carried out in at least one machine-dependent assembler language in which the assembler commands, with the exception of conditional program jumps or program branches, respectively, can be executed
in essence independently of data, characterized by at least one random number generator assigned to the microcontroller can be executed, by means of which the program jumps or program branches can be executed
in dependence on the state of the random number generator and/or independently of the internal state of the programming of the microcontroller.

2. A microcontroller as claimed in claim 1, characterized by at least one, in particular bit-addressable, random number register assigned to the random number generator.

3. A microcontroller as claimed in claim 1, characterized by an embodiment as a smartcard controller.

4. An electrical or electronic device controlled by means of at least one microcontroller as claimed in claim 1.

5. A method for processing the programming of a microcontroller executed in at least one machine-dependent assembler language, the assembler commands, with the exception of conditional program jumps or branches, being executed essentially independently of data, characterized in that the program jumps or program branches are executed
in dependence on the state of at least one random number generator and/or
independently of the internal state of the programming of the microcontroller.

6. A method as claimed in claim 5, characterized in that the random number generated by the random number generator read via software via registers and the random number read is then evaluated with a conditional program jump or branch.

7. A method as claimed in claim 5, characterized in that, if at least one, in particular bit-addressable, random number register is present, testing per bit of the random number register and a conditional jump or branch is carried out.

8. A method as claimed in claim 5, characterized by the implementation of at least one assembler command (“branch on random bit”), a defined bit of the random number register being supplied, in particular directly, to the condition input for the conditional jump or branch.

9. A method as claimed in claim 5, characterized in that at least one Arithmetic Logic Unit (ALU) flag controlling the conditional jumps or branches is replaced, in particular via the software, by at least one bit of the random number register, so that the conditional jumps or branches corresponding to the bit of the Arithmetic Logic Unit are controlled by the bit of the Random Number Register.

10. A use of a microcontroller as claimed in at least one of claims 1 to 3 and/or of a method as claimed in claim 5 for completely concealing the programming running on the microcontroller, so that at least one program running on the microcontroller is unpredictable and non-reproducible for an external observer.
